(19) United States
(12) Patent Application Publication
(10) Pub. No.: US 2026/0255426 A1
(43) Pub. Date: Aug. 27, 2026

(54) SYSTEM AND METHOD FOR ACTIVE BANDWIDTH PART (BWP) SELECTION

(71) Applicant: JIO PLATFORMS LIMITED, Ahmedabad (IN)

(72) Inventors: Tushar DUTTA, Bangalore (IN); N L Sairambabu KANCHARLAPALLI, Bengaluru (IN); Aayush BHATNAGAR, Navi Mumbai (IN); Pradeep Kumar BHATNAGAR, Navi Mumbai (IN)

(73) Assignee: JIO PLATFORMS LIMITED, Ahmedabad (IN)

(21) Appl. No.: 18/992,263

(22) PCT Filed: May 20, 2024
(86) PCT No.: PCT/IN2024/050590

§ 371 Date: Jan. 8, 2025

(30) Foreign Application Priority Data
Jun. 29, 2023 (IN) 202321043757

(51) Int. Cl. H04W 76/20; H04W 24/10; H04W 72/0453; H04W 72/51; H04W 76/10; H04W 76/50

(52) U.S. Cl. CPC H04W 76/20; H04W 24/10; H04W 72/0453; H04W 72/51; H04W 76/10; H04W 76/50

(57) ABSTRACT

The present disclosure is related to a method of selecting at least one bandwidth part for a user equipment (UE) (204) connected to a network (203). The method includes receiving a radio resource control (RRC) connection setup request from the UE (204). The method includes checking an establishment cause associated with the received RRC connection setup request. The method comprises configuring a plurality of bandwidth parts based on the checked establishment cause. The method includes selecting at least one bandwidth part from the plurality of configured bandwidth parts. The method includes allocating, to the UE (204), the at least one selected bandwidth part. The method includes transmitting, to the UE (204), an RRC reconfiguration message comprising the allocated at least one bandwidth part and attaching the UE (204) to the allocated at least one bandwidth part.

### RESERVATION OF RIGHTS

A portion of the disclosure of this patent document contains material which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to wireless communications, and specifically to a system and a method for selecting an active Bandwidth Part (BWP) upon receiving a connection setup request.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Conventional mechanisms for selecting an active Bandwidth Part (BWP) from multiple available BWPs are inefficient. This is due to non-consideration of BWP attributes such as Subcarrier Spacing (SCS), load, aggregation level, core set size, interleaved/non-interleaved Control Channel Element (CCE) indexes, and channel report during the selection and may result in an incorrect matching of the active BWP with respect to a service request received from a User Equipment (UE).

There is, therefore, a need in the art for an improved mechanism to select the active BWP that best matches the service request based on the BWP attributes.

### DEFINITION

As used in the present disclosure, the following terms are generally intended to have the meaning as set forth below, except to the extent that the context in which they are used to indicate otherwise.

The term RRC as used herein, refers to radio resource control. The RRC is a protocol is used in Universal Mobile Telecommunications Service (UMTS), long-term evolution (LTE) and 5G on the air interface. It is a layer 3 (network layer) protocol used between a user equipment (UE) and a base station.

The term SCS as used herein, refers to subcarrier spacing. The SCS is the distance between two adjacent subcarriers in an Orthogonal Frequency Division Multiplexing (OFDM) signal. It is a key parameter that affects the bandwidth and performance of a 5G network.

The term SSB as used herein, refers to synchronization signal block. The SSB is used by the UE for 5G NR cell search and synchronization.

The term CORESET as used herein refers to the control resource set. The CORESET is a set of physical resources (i.e., a specific area on the NR downlink resource grid) and a set of parameters that are used to carry Physical Downlink Control Channel (PDDCH))/Downlink Channel Indicator (DCI).

The term PUSCH as used herein, refers to Physical Uplink Shared Channel. The E-UTRA PUSCH is the main uplink channel and is used to carry the uplink shared channel (UL-SCH) transport channel.

The term PUCCH, as used herein, refers to the Physical Uplink Control Channel. The PUCCH carries a set of information called Uplink Control Information (UCI).

The term NAS as used herein, refers to non-access stratum. The Non-Access Stratum (NAS) is a functional layer running between the User Equipment (UE) and the Core Network (CN).

The term BWP as used herein, refers to bandwidth part. The BWP is a part of the total channel bandwidth configured for a cell that is used for a UE at a specific moment of operation.

### OBJECTS OF THE PRESENT DISCLOSURE

It is an object of the present disclosure to select an active Bandwidth Part (BWP) upon receiving a Radio Resource Control (RRC) setup request.

It is an object of the present disclosure to allocate the active BWP to a User Equipment (UE) while considering BWP attributes.

It is an object of the present disclosure to select the active BWP based on either of a BWP subcarrier spacing attribute, an aggregation level attribute, a current load attribute that best matches a requested service.

It is an object of the present disclosure to provide better resource utilization for a wireless network leading to enhanced user experience.

It is an object of the present disclosure to prioritize the BWP attributes based on an establishment cause mentioned in the received RRC setup request.

### SUMMARY

In an exemplary embodiment, the present invention discloses a method of selecting at least one bandwidth part for a user equipment (UE) connected to a network. The method comprising receiving a radio resource control (RRC) connection setup request from the UE. The method comprising checking an establishment cause associated with the received RRC connection setup request. The method comprising configuring a plurality of bandwidth parts based on the checked establishment cause. The method comprising selecting at least one bandwidth part from the plurality of configured bandwidth parts. The method comprising allocating, to the UE, the at least one selected bandwidth part. The method comprising transmitting, to the UE, a RRC reconfiguration message comprising the allocated at least one bandwidth part. The method comprising attaching the UE to the at least one allocated bandwidth part.

In some embodiments, the establishment cause includes of a plurality of parameters associated with a service requirement of the UE.

In some embodiments, the plurality of configured bandwidth parts comprises of a plurality of bandwidth part characteristics.

In some embodiments, the method further comprising matching the plurality of bandwidth part characteristics with the plurality of parameters.

In some embodiments, the method further comprising ranking the plurality of bandwidth parts based on the matched plurality of bandwidth part characteristics.

In some embodiments, the method further comprising selecting the at least one bandwidth part from the plurality of ranked bandwidth parts.

In some embodiments, the at least one selected bandwidth part comprises of at least one bandwidth part characteristic having a maximum match with the plurality of parameters included in the establishment cause.

In some embodiments, the method the plurality of parameters included in the establishment cause comprising one or more of an emergency access, a high priority access, a mobile terminating (MT) access, a mobile originating (MO) signalling, a mobile originating (MO) data, a mobile originated (MO) voice call, a mobile originated (MO) video call, a mobile originated SMS, a multimedia priority service (MPS) priority access, and a mission critical service (MCS) priority access.

In some embodiments, the plurality of bandwidth part characteristics comprising one or more of a subcarrier spacing (SCS), load, an aggregation level, a coreset size, interleaved control channel element (CCE) indexes, non-interleaved control channel element (CCE) indexes, and channel report.

In some embodiments, the method further comprising monitoring a channel measurement report of the UE attached to the at least one allocated bandwidth part.

In some embodiments, the method further comprising switching the UE to at least one other ranked bandwidth part based on the monitored channel measurement report.

In an exemplary embodiment, the present invention discloses a system for selecting at least one bandwidth part for a user equipment (UE) connected to a network. The system comprising a receiving unit (212) configured to receive a radio resource control (RRC) connection setup request from the UE. The system comprising a processing unit (214) configured to check an establishment cause associated with the received RRC connection setup request. The system is configured to configure a plurality of bandwidth parts based on the checked establishment cause. The system is configured to select at least one bandwidth part from the plurality of configured bandwidth parts. The system is configured to allocate, to the UE, the at least one selected bandwidth part. The system is configured to transmit, to the UE, a RRC reconfiguration message comprising the allocated at least one bandwidth part. The system is configured to attach the UE to the at least one allocated bandwidth part.

In some embodiments, the establishment cause includes of a plurality of parameters associated with a service requirement of the UE.

In some embodiments, the plurality of configured bandwidth parts comprises of a plurality of bandwidth part characteristics.

In some embodiments, the system is configured to match the plurality of bandwidth part characteristics with the plurality of parameters.

In some embodiments, the system is configured to rank the plurality of bandwidth parts based on the matched plurality of bandwidth part characteristics.

In some embodiments, the system is configured to select the at least one bandwidth part from the plurality of ranked bandwidth parts.

In some embodiments, the at least one selected bandwidth part comprises of at least one bandwidth part characteristic having a maximum match with the plurality of parameters included in the establishment cause.

In some embodiments, the plurality of parameters included in the establishment cause comprising one or more of an emergency access, a high priority access, a mobile terminating (MT) access, a mobile originating (MO) signalling, a mobile originating (MO) data, a mobile originated (MO) voice call, a mobile originated (MO) video call, a mobile originated SMS, a multimedia priority service (MPS) priority access, and a mission critical service (MCS) priority access.

In some embodiments, the plurality of bandwidth part characteristics comprising one or more of a subcarrier spacing (SCS), load, an aggregation level, a coreset size, interleaved control channel element (CCE) indexes, non-interleaved control channel element (CCE) indexes, and channel report.

In some embodiments, the system is configured to monitor a channel measurement report of the UE attached to the at least one allocated bandwidth part.

In some embodiments, the system is configured to switch the UE to at least one other ranked bandwidth part based on the monitored channel measurement report.

In an exemplary embodiment, the present invention discloses network comprising one or more network elements for selecting at least one bandwidth part for a user equipment (UE) communicatively coupled to the network. The one or more network elements are configured to receive a radio resource control (RRC) connection setup request from the UE. The system is configured to check an establishment cause associated with the received RRC connection setup request. The system is configured to configure a plurality of bandwidth parts based on the checked establishment cause. The system is configured to select at least one bandwidth part from the plurality of configured bandwidth parts. The system is configured to allocate, to the UE, the at least one selected bandwidth part. The system is configured to transmit, to the UE, a RRC reconfiguration message comprising the allocated at least one bandwidth part. The system is configured to attach the UE to the at least one allocated bandwidth part.

In an exemplary embodiment, the present invention discloses user equipment (UE) communicatively coupled with a network. The network comprising one or more network elements configured for receiving a radio resource control (RRC) connection setup request from the UE, sending an acknowledgment of the RRC connection setup request to the UE, and checking an establishment cause associated with the received RRC connection setup request for configuring a plurality of bandwidth parts. The one or more network elements are further configured for allocating, to the UE, the at least one bandwidth part and transmitting, to the UE, a RRC reconfiguration message for attaching the UE to the at least one bandwidth part.

The foregoing general description of the illustrative embodiments and the following detailed description thereof are merely exemplary aspects of the teachings of this disclosure and are not restrictive.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary representation of elements of a Radio Resource Control (RRC) setup request including an establishment cause, in accordance with an embodiment of the present disclosure.

FIG. 2A illustrates a network architecture for selecting at least one bandwidth part for a user equipment (UE), in accordance with embodiments of the present disclosure.

FIG. 2B illustrates an exemplary flow representation for a selection of an active Bandwidth Part (BWP) upon receiving a Radio Resource Control (RRC) setup request, in accordance with an embodiment of the present disclosure.

FIG. 3 illustrates an exemplary flow representation of the UE switching the BWP based on a generated periodic channel report, in accordance with an embodiment of the present disclosure.

FIG. 4 illustrates an exemplary computer system in which or with which embodiments of the present disclosure may be implemented.

FIG. 5 illustrates an exemplary flow chart for selecting at least one bandwidth part for the UE, in accordance with an embodiment of the present disclosure.

### LIST OF REFERENCE NUMERALS

100—Exemplary representation of Radio Resource Control (RRC) setup request
200A—Network architecture
202, 302—gNodeB (gNB)/access and mobility function (AMF)
203—Network
204, 304—User equipment (UE)
210—System
212—Receiving unit
214—Processing unit
216—Database
218—Interfacing unit
200B—Flow diagram
300—Flow diagram
400—A computer system
410—External storage device
420—Bus
430—Main memory
440—Read only memory
450—Mass storage device
460—Communication port(s)
470—Processor
500—Flow diagram

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,”“contains,” and other similar words are used in either the detailed description or the claims, such terms are intended to be inclusive-in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Bandwidth Parts (BWPs) is a Fifth Generation (5G) New Radio (NR) feature introduced in 3rd Generation Partnership Project (3GPP) Release 15. The BWP dynamically adapts carrier bandwidth and numerology in which a User Equipment (UE) operates. The BWP allows supporting multiple services per carrier, for example, an Enhanced Mobile Broadband (eMBB) service, and a Massive Machine-Type Communications (mMTC) service.

The disclosed system and method facilitate to choose an appropriate active BWP based on a service request mentioned in a received Radio Resource Control (RRC) connection establishment request. The appropriate active BWP may be selected based on the real-time status of one or more attributes of each of the BWPs. The attributes may be, for example, Subcarrier Spacing (SCS), load, aggregation level, coreset size, interleaved/non-interleaved Control Channel Element (CCE) indexes, channel report. The appropriate active BWP may be selected based on one of the establishment causes that is prioritized during the RRC setup establishment. The establishment cause may be, for example, Mobile Originated (MO) signalling/data, Mobile Terminated (MT) access, emergency, high-priority access, and the like.

As may be appreciated, the BWP is a carrier bandwidth part that is a contiguous set of physical resource blocks, selected from a contiguous subset of the common resource blocks for a given numerology (u) on a given carrier.

The BWP allocation for Downlink (DL) involves:
1. The UE to be configured with up to four carrier bandwidth parts.
2. Setting the bandwidth of each of the Bandwidth part (BWP) to be equal or greater than Synchronization Signal Block (SSB) BW, but it may or may not contain SSB.
3. Setting only one carrier BWP to be active at a given time.
4. The UE to not expect to receive a physical downlink shared channel (PDSCH), Physical Downlink Control Channel (PDCCH), Channel-State Information-Reference Signals (CSI-RS), or Tracking Reference Signal (TRS) outside an active BWP.
5. Each DL BWP is to include at least one Control Resource Set (CORESET) with UE Specific Search Space (USS).
6. In a primary carrier, at least one of the configured DL BWPs may include one CORESET with common search space (CSS).

The BWP allocation for Uplink (UL) involves:
1. The UE is to be configured with up to four carrier bandwidth parts.
2. Only one carrier bandwidth part may be active at a given time.
3. If a UE is configured with a supplementary uplink
4. The UE may, in addition, be configured with up to four carrier bandwidth parts in a supplementary uplink.
5. Only one carrier bandwidth part may be active at a given time.
6. The UE may not transmit the PUSCH or the PUCCH outside an active bandwidth part.

In an example, the establishment cause in the RRC setup request may be, for example, an emergency, a high priority access, a mobile terminating access, a mobile originating signalling, a mobile originating data, and the like. In some examples, the establishment cause may be determined by a Non-access stratum (NAS) procedure for which the RRC setup is being established.

An initial step in a 5G Standalone (SA) call processing is to synchronize the UE with a gNodeB (gNB). After synchronization, the UE may initiate the RRC setup establishment procedure by sending an RRC SetupRequest message to the gNB. Further, the gNB may respond with an RRC Setup message, which includes essential configuration information for the UE to access network resources.

As per 3GPP Technical Specification (TS) 38.331, the establishment cause may be represented as:
EstablishmentCause:=ENUMERATED {emergency, highPriority Access, MT-Access, MO-Signalling, MO-Data, MO-VoiceCall, MO-VideoCall, MO-SMS, Multimedia Priority Service ((MPS)-Priority Access, Mission Critical Service (MCS)-Priority Access, spare6, spare5, spare4, spare3, spare2, spare1}

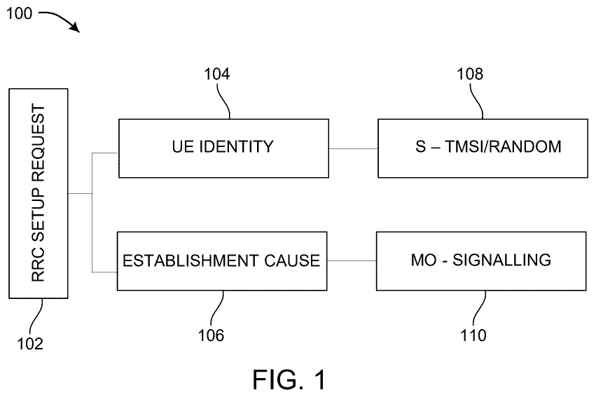

FIG. 1 illustrates an exemplary representation 100 of elements of the RRC setup request including the establishment cause, in accordance with an embodiment of the present disclosure. As illustrated, the RRC setup request (102) includes parameters such as UE-Identity (104), and the establishment cause (106). The UE-Identity (104) may be, for example, a Serving Temporary Mobile Subscriber Identity (S-TMSI) or it may be a random allocated identity.

In an embodiment, selection of the active BWP is initiated when the gNB receives the RRC setup request at step (102). Upon receiving the RRC setup request, the establishment cause is evaluated. Based on the evaluation, for the connection request cases with the establishment cause mentioned as, for example, the MO voice, the MT voice, and the MCS/MPS high priority access, an active BWP may be configured that has a low latency (i.e., high sub carrier spacing), low load, and higher aggregation level, i.e., better channel measurement reports. In addition, for the connection request cases with the establishment cause mentioned as the MO data or the MT access, any active BWP may be assigned whose load or channel characteristics have the capacity to service the requested connection request.

In addition, a BWP ranking may be generated for each of the available BWP based on the channel characteristics. The BWP ranking may be generated for each of the requested services of the RRC setup request. Based on the generated BWP ranking, an active BWP may be selected that best suits the requested service in the establishment cause. The BWP may be ranked in an ascending order based on attributes such as SCS, load, aggregation level, core set size, interleaved/non-interleaved CCE indexes, and channel report. In an aspect, the BWP may be ranked in descending order based on the attributes such as SCS, load, aggregation level, core set size, interleaved/non-interleaved CCE indexes, channel report, etc. In an aspect, the BWP may be ranked using a combination of one or more attributes such as SCS, load, aggregation level, core set size, interleaved/non-interleaved CCE indexes, channel report, etc, in ascending or descending order. In an aspect, the BWP may be ranked based on a weightage of the one or more attributes such as SCS, load, aggregation level, core set size, interleaved/non-interleaved CCE indexes, and channel report etc.

Further, a channel measurement report may be generated when the UE is attached to the active BWP. The channel measurement report may be monitored regularly to determine if the selected active BWP satisfies the requested service. Else, selection of the active BWP is switched to the next best BWP.

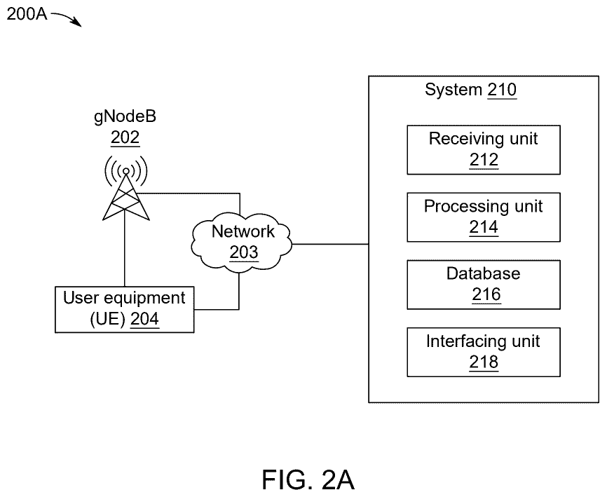

FIG. 2A illustrates a network architecture for selecting at least one bandwidth part for a user equipment (UE), in accordance with embodiments of the present disclosure.

Referring to FIG. 2A, the network architecture (200A) may include a user equipment UE (204) and a gNodeB (202). A person of ordinary skill in the art will understand that. A person of ordinary skill in the art will appreciate that the terms “computing device(s)” and “user equipment” may be used interchangeably throughout the disclosure. Although a single UE (204) is depicted in FIG. 1, however, any number of the UEs may be included without departing from the scope of the ongoing description.

In an embodiment, the UE (204) may include smart devices operating in a smart environment, for example, an Internet of Things (IOT) system. In such an embodiment, the UE (204) may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users and/or entities, or any combination thereof. A person of ordinary skill in the art will appreciate that the UE (204) may include, but is not limited to, intelligent, multi-sensing, network-connected devices, that can integrate seamlessly with each other and/or with a central server or a cloud-computing system or any other device that is network-connected.

In an embodiment, the UE (204) may include, but is not limited to, a handheld wireless communication device (e.g., a mobile phone, a smart phone, a phablet device, and so on), a wearable computer device(e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the UE (204) may include, but is not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the UE (204) may include one or more in-built or externally coupled accessories including, but not limited to, a visual aid device such as a camera, an audio aid, a microphone, a keyboard, and input devices for receiving input from the user (102) or the entity such as touch pad, touch enabled screen, electronic pen, and the like. A person of ordinary skill in the art will appreciate that the UE (204) may not be restricted to the mentioned devices and various other devices may be used.

The UE (204) may communicate with a system (210), through a network (203). In an embodiment, the network (203) may include at least one of a Second Generation (2G), Third Generation (3G), Fourth Generation (4G) network, a Fifth Generation (5G) network, Sixth Generation (6G) and beyond or the like. The network (203) may enable the user equipment (204) to communicate with other devices in the network architecture (200A) and/or with the system (210). The network (203) may include a wireless card or some other transceiver connection to facilitate this communication. In another embodiment, the network (203) may be implemented as or include any of a variety of different communication technologies such as a wide area network (WAN), a local area network (LAN), a wireless network, a mobile network, a Virtual Private Network (VPN), the Internet, the Public Switched Telephone Network (PSTN), or the like.

The system (210) may include a receiving unit (212), a processing unit (214), a database (216), and an interfacing unit (218). The receiving unit (212) is configured to receive a radio resource control (RRC) connection setup request from the UE. The processing unit (214) is coupled to the receiving unit (212). The processing unit (214) is configured to check an establishment cause associated with the received RRC connection setup request. The RRC connection setup request is a message used in cellular networks, particularly in the context of LTE (Long-Term Evolution) and 5G networks. When a device, such as a smartphone or IoT device, wants to establish a connection with the network, it sends an RRC connection setup request to the base station (eNodeB in LTE or gNodeB in 5G). The RRC connection setup request includes essential information such as the device's identity, capabilities, and the type of service it is requesting. Upon receiving this request, a base station processes it and initiates the necessary procedures to establish a connection with the device, allowing it to access the network services.

Further, the processing unit (214) configures a plurality of bandwidth parts based on the checked establishment cause. The processing unit (214) is configured to select at least one bandwidth part from the plurality of configured bandwidth parts. The processing unit (214) allocates at least one selected bandwidth part to the UE (204) and transmits the RRC reconfiguration message comprising the allocated at least one bandwidth part to the UE (204). The RRC reconfiguration message includes instructions for the device to adjust its radio configuration parameters, such as modulation and coding schemes, bandwidth allocation, power control, handover parameters, and other network-related settings along with the allocated at least one bandwidth part. The RRC reconfiguration message allows the network to adapt dynamically to changing conditions, optimize resource allocation, and enhance overall network performance while maintaining the continuity of service for connected devices.

Further, the processing unit (214) attaches the UE (204) to the at least one allocated bandwidth part. The processing unit (214) may be implemented as one or more microprocessors, microcomputers, microcontrollers, digital signal processors, central processing units, logic circuitries, and/or any devices that process data based on operational instructions. Among other capabilities, the processing unit (214) may be configured to fetch and execute computer-readable instructions stored in a memory of the system (210). The memory may be configured to store one or more computer-readable instructions or routines in a non-transitory computer readable storage medium, which may be fetched and executed to create or share data packets over a network service. The memory may comprise any non-transitory storage device including, for example, volatile memory such as random-access memory (RAM), or non-volatile memory such as erasable programmable read only memory (EPROM), flash memory, and the like. The database (216) may store information including the RRC connection setup request, the RRC configuration message, bandwidth parts, and the like.

In an embodiment, the interfacing unit (218) may comprise a variety of interfaces, for example, interfaces for data input and output devices (I/O), storage devices, and the like. The interfacing unit (218) may facilitate communication through the system (210). The interfacing unit (218) may also provide a communication pathway for one or more components of the system (210).

FIG. 2B illustrates an exemplary flow representation 200B for the selection of the active BWP upon receiving the RRC setup request, in accordance with an embodiment of the present disclosure. As is illustrated, at 206, step 1, the UE 204 sends the RRC setup request with the establishment cause mentioned as MO Voice (i.e., a high-priority access) to the gNB/AMF 202. Upon receiving the request, the gNB, at 208, step 2, evaluates a best BWP out of available four BWPs based on the attributes such as the SCS, the load, and channel estimates. The BWP that best matches a service request received from the RRC setup request is selected as the active BWP for the UE. By way of an example, a high-priority access request may require a BWP that supports low latency (i.e., high SCS), low load, and has the best channel characteristics (or maximum match with the plurality of parameters included in the establishment clause). Further, a RRC setup message is sent to the UE having information about an active BWP with index 2. The UE sets the BWP as the active BWP with the index 2. The BWP whose subcarrier spacing, load, and channel configuration best matches the service and latency requirements for the type of service requested may be set as the active BWP. The matching of parameters helps in finding the correct BWP. Further, the service level agreement (SLA) requirement for the requested service should be fulfilled by the BWP (to be selected). Thus, this mechanism for selection of the active BWP enables better resource utilization and provides enhanced user experience.

In an embodiment are disclosed various scenarios for mapping of the establishment cause to the BWP attributes:
Scenario 1: For establishment cause mentioned as: MO/MT VoiceCall/VideoCall:
   1. Rank the BWP as per highest Sub Carrier Spacing (SCS) to lowest for lowest latency requirement.
   2. Perform next level ranking on Aggregation Level (AL) (higher AL is ranked higher)
   3. Perform next level ranking on load on the BWP (lowest load ranked higher)
Scenario 2: For establishment cause mentioned as: Emergency/High Priority Access
   1. Rank the BWP based on the AL (higher AL is ranked higher)
   2. Perform next level ranking on load on the BWP (lowest load ranked higher)
Scenario 3: For establishment cause mentioned as: MobileOriginatingSignalling/MO-SMS
   1. Rank the BWP based on the AL (higher AL is ranked higher)
   2. Perform next level ranking on the load on the BWP (lowest load ranked higher)
Scenario 4: For establishment cause mentioned as: MCS-Priority Access
   1. Rank the BWP as per highest SCS to lowest for lowest latency requirement.
   2. Perform next level ranking on the AL (higher AL ranked higher)
   3. Perform next level ranking on the load on the BWP (lowest load ranked higher)
Scenario 5: For establishment cause mentioned as: MPS-Priority Access
   1. Rank the BWP as per highest SCS to lowest for lowest latency requirement.
   2. Perform next level ranking on the load on the BWP (lowest load ranked higher)
Scenario 6: For establishment cause mentioned as: MO/MT Data
   1. Rank the BWP as per Load on the BWP (lowest load ranked higher)

As may be appreciated, the BWP attributes such as the Core set size, the CCE indexes (interleaved/non-interleaved), and the other BWP attributes may be taken into account to determine the best suit for the establishment cause service. In addition, after selecting a particular BWP as the active BWP, periodic channel measurement may be performed and monitored. Also, switching to the next best BWP ranking may be done if current channel reports are not sufficient enough to sustain the Quality Of service (QOS) requirements of the establishment cause service.

In an exemplary embodiment, the present invention discloses a method of selecting at least one bandwidth part for a user equipment (UE). The method comprises receiving a radio resource control (RRC) connection setup request from the UE. The method comprises checking an establishment cause associated with the received RRC connection setup request. The method comprises configuring a plurality of bandwidth parts based on the checked establishment cause. The method comprises selecting at least one bandwidth part from the plurality of configured bandwidth parts. The method comprises allocating, to the UE, at least one selected bandwidth part. The method comprises transmitting, to the UE, an RRC reconfiguration message comprising the allocated at least one bandwidth part. The method comprises attaching the UE to at least one allocated bandwidth part.

In some embodiments, the establishment cause includes of a plurality of parameters associated with a service requirement of the UE.

In some embodiments, the plurality of configured bandwidth parts comprises a plurality of bandwidth part characteristics.

In some embodiments, the method further comprises matching the plurality of bandwidth part characteristics with the plurality of parameters.

In some embodiments, the method further comprises ranking the plurality of bandwidth parts based on the matched plurality of bandwidth part characteristics.

In some embodiments, the method further comprises selecting at least one bandwidth part from the plurality of ranked bandwidth parts.

In some embodiments, at least one selected bandwidth part comprises at least one bandwidth part characteristic having a maximum match with the plurality of parameters included in the establishment clause.

In some embodiments, the method the plurality of parameters included in the establishment cause comprising one or more of emergency access, a high priority access, a mobile terminating (MT) access, a mobile originating (MO) signalling, a mobile originating (MO) data, a mobile originated (MO) voice call, a mobile originated (MO) video call, a mobile originated SMS, a multimedia priority service (MPS) priority access, and a mission-critical service (MCS) priority access.

In some embodiments, the plurality of bandwidth part characteristics comprising one or more of a subcarrier spacing (SCS), load, an aggregation level, a coreset size, interleaved control channel element (CCE) indexes, non-interleaved control channel element (CCE) indexes, and channel report.

In some embodiments, the method further comprises monitoring a channel measurement report of the UE attached to at least one allocated bandwidth part.

In some embodiments, the method further comprises switching the UE to at least one other ranked bandwidth part based on the monitored channel measurement report.

In an exemplary embodiment, the present invention discloses a system for selecting at least one bandwidth part for a user equipment (UE). The system is configured to receive a radio resource control (RRC) connection setup request from the UE. The system is configured to check an establishment cause associated with the received RRC connection setup request. The system is configured to configure a plurality of bandwidth parts based on the checked establishment cause. The system is configured to select at least one bandwidth part from the plurality of configured bandwidth parts. The system is configured to allocate, to the UE, the at least one selected bandwidth part. The system is configured to transmit, to the UE, a RRC reconfiguration message comprising the allocated at least one bandwidth part. The system is configured to attach the UE to the at least one allocated bandwidth part.

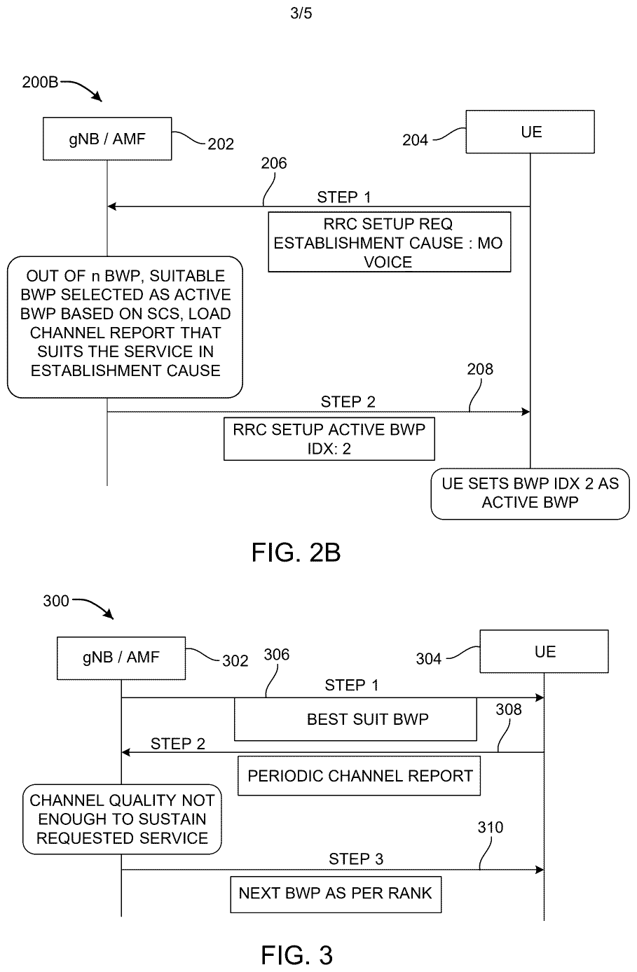

FIG. 3 illustrates an exemplary flow representation 300 of the UE 304 switching the BWP based on a generated periodic channel report, in accordance with an embodiment of the present disclosure. As is illustrated, at 306, step 1, the

UE is informed about a best-suited active BWP by the Gnb/AMF 302. The UE attaches itself to the best-suited active BWP and periodically generates a channel report. At 308 step 2, the periodically generated channel report is shared with the gNB comprising information related to quality and performance of the active BWP. When the report is not satisfactory and implies that the channel quality of the selected BWP is not enough to sustain the requested service, the gNB, at 310 step 3, informs the UE of the next best available active BWP to be used. The next best active BWP is selected based on the rank assigned to each of the available BWP.

The disclosure facilitates the provision of a system and a method for allocating the active BWP to the UE based on the establishment cause mentioned in the RRC setup request. The BWP whose subcarrier spacing, load, and channel configuration best matches the service and latency requirements for the type of service requested may be set as the active BWP. This mechanism for selection of the active BWP enables better resource utilization and provides enhanced user experience.

In an aspect, the present disclosure prioritizes the BWP attributes based on an establishment cause mentioned in the received RRC setup request. In an aspect the present invention can be implemented in a wireless communication network architecture for better resource utilization.

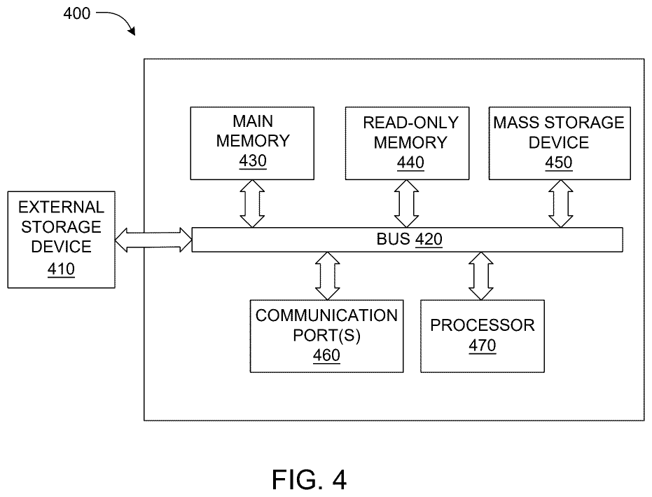

FIG. 4 illustrates an exemplary computer system 400 in which or with which embodiments of the present disclosure may be implemented. As shown in FIG. 4, the computer system 400 may include an external storage device 410, a bus 420, a main memory 430, a read-only memory 440, a mass storage device 450, communication port(s) 460, and a processor 470. A person skilled in the art will appreciate that the computer system 400 may include more than one processor and communication ports. The processor 470 may include various modules associated with embodiments of the present disclosure. The communication port(s) 460 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 460 may be chosen depending on a network, such a Local Area Network (LAN), Wide Area Network (WAN), or any network to which the computer system 400 connects.

The main memory 430 may be random access memory (RAM), or any other dynamic storage device commonly known in the art. The read-only memory 440 may be any static storage device(s) e.g., but not limited to, a Programmable Read Only Memory (PROM) chips for storing static information e.g., start-up or Basic Input/Output System (BIOS) instructions for the processor 470. The mass storage device 450 may be any current or future mass storage solution, which can be used to store information and/or instructions. Exemplary mass storage device 450 includes, but is not limited to, Parallel Advanced

Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

The bus 420 communicatively couples the processor 470 with the other memory, storage, and communication blocks. The bus 420 may be, e.g. a Peripheral Component Interconnect (PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor 470 to the computer system 400.

Optionally, operator and administrative interfaces, e.g., a display, keyboard, joystick, and a cursor control device, may also be coupled to the bus 420 to support direct operator interaction with the computer system 400. Other operator and administrative interfaces can be provided through network connections connected through the communication port(s) 460. Components described above are meant only to exemplify various possibilities. In no way should the aforementioned exemplary computer system 400 limit the scope of the present disclosure.

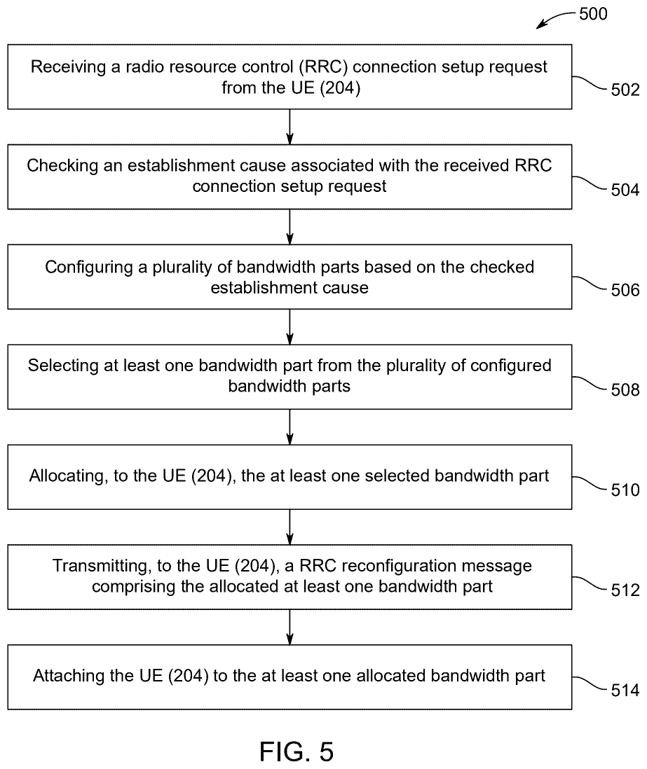

FIG. 5 illustrates an exemplary flow diagram 500 for a method of selecting at least one bandwidth part for a user equipment (UE) (204) connected to a network (203).

At step 502, the method includes receiving a radio resource control (RRC) connection setup request from the UE (204).

At step 504, the method includes checking an establishment cause associated with the received RRC connection setup request.

At step 506, the method includes configuring a plurality of bandwidth parts based on the checked establishment cause.

At step 508, the method includes selecting at least one bandwidth part from the plurality of configured bandwidth parts.

At step 510, the method includes allocating, to the UE (204), the at least one selected bandwidth part.

At step 512, the method includes transmitting, to the UE (204), a RRC reconfiguration message comprising the allocated at least one bandwidth part.

At step 514, the method includes attaching the UE (204) to the at least one allocated bandwidth part.

In some embodiments, the establishment cause includes of a plurality of parameters associated with a service requirement of the UE. In some embodiments, the plurality of configured bandwidth parts comprises of a plurality of bandwidth part characteristics. In some embodiments, the method further comprises matching the plurality of bandwidth part characteristics with the plurality of parameters. In some embodiments, the method further comprises ranking the plurality of bandwidth parts based on the matched plurality of bandwidth part characteristics. In some embodiments, the method further comprises selecting at least one bandwidth part from the plurality of ranked bandwidth parts. In some embodiments, at least one selected bandwidth part comprises at least one bandwidth part characteristic having a maximum match with the plurality of parameters included in the establishment clause. In some embodiments, the method the plurality of parameters included in the establishment cause comprising one or more of an emergency access, a high priority access, a mobile terminating (MT) access, a mobile originating (MO) signalling, a mobile originating (MO) data, a mobile originated (MO) voice call, a mobile originated (MO) video call, a mobile originated SMS, a multimedia priority service (MPS) priority access, and a mission critical service (MCS) priority access. In some embodiments, the plurality of bandwidth part characteristics comprising one or more of a subcarrier spacing (SCS), load, an aggregation level, a coreset size, interleaved control channel element (CCE) indexes, non-interleaved control channel element (CCE) indexes, and channel report. In some embodiments, the method further comprises monitoring a channel measurement report of the UE attached to at least one allocated bandwidth part. In some embodiments, the method further comprises switching the UE to at least one other ranked bandwidth part based on the monitored channel measurement report.

In an exemplary embodiment, the present invention discloses a system for selecting at least one bandwidth part for a user equipment (UE) connected to a network. The system comprises a receiving unit (212) configured to receive a radio resource control (RRC) connection setup request from the UE. The system comprises a processing unit (214) configured to check an establishment cause associated with the received RRC connection setup request. The system is configured to configure a plurality of bandwidth parts based on the checked establishment cause. The system is configured to select at least one bandwidth part from the plurality of configured bandwidth parts. The system is configured to allocate, to the UE, the at least one selected bandwidth part. The system is configured to transmit, to the UE, a RRC reconfiguration message comprising the allocated at least one bandwidth part. The system is configured to attach the UE to the at least one allocated bandwidth part.

In an exemplary embodiment, the present invention discloses network comprising one or more network elements for selecting at least one bandwidth part for a user equipment (UE) communicatively coupled to the network. The one or more network elements are configured to receive a radio resource control (RRC) connection setup request from the UE. The system is configured to check an establishment cause associated with the received RRC connection setup request. The system is configured to configure a plurality of bandwidth parts based on the checked establishment cause. The system is configured to select at least one bandwidth part from the plurality of configured bandwidth parts. The system is configured to allocate, to the UE, the at least one selected bandwidth part. The system is configured to transmit, to the UE, a RRC reconfiguration message comprising the allocated at least one bandwidth part. The system is configured to attach the UE to the at least one allocated bandwidth part.

In an exemplary embodiment, the present invention discloses user equipment (UE) communicatively coupled with a network. The network comprising one or more network elements configured for receiving a radio resource control (RRC) connection setup request from the UE, sending an acknowledgment of the RRC connection setup request to the UE, and checking an establishment cause associated with the received RRC connection setup request for configuring a plurality of bandwidth parts. The one or more network elements are further configured for allocating, to the UE, the at least one bandwidth part and transmitting, to the UE, a RRC reconfiguration message for attaching the UE to the least one bandwidth part.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

The present disclosure facilitates selection of an active Bandwidth Part (BWP) upon receiving a Radio Resource Control (RRC) setup request.

The present disclosure allocates the active BWP to a User Equipment (UE) while considering BWP attributes.

The present disclosure selects the active BWP based on a BWP subcarrier spacing attribute, an aggregation level attribute, a current load attribute that best matches a requested service.

The present disclosure provides better resource utilization of a wireless network and enhanced user experience.

The present disclosure prioritizes the BWP attributes based on an establishment cause mentioned in the received RRC setup request.

1. A method (500) of selecting a bandwidth part for a user equipment (UE) (204) connected to a network (203), the method comprising:
receiving (502) a radio resource control (RRC) connection setup request from the UE (204);
checking (504) an establishment cause associated with the received RRC connection setup request;
configuring (506) a plurality of bandwidth parts based on the checked establishment cause;
selecting (508) at least one bandwidth part from the plurality of configured bandwidth parts;
allocating (510), to the UE (204), the at least one selected bandwidth part;
transmitting (512), to the UE (204), a RRC reconfiguration message comprising the allocated at least one bandwidth part; and
attaching (514) the UE (204) to the allocated at least one bandwidth part.

2. The method (500) as claimed in claim 1, wherein the establishment cause includes a plurality of parameters associated with a service requirement of the UE (204).

3. The method (500) as claimed in claim 2, wherein the plurality of configured bandwidth parts comprises a plurality of bandwidth part characteristics.

4. The method (500) as claimed in claim 3, further comprising matching the plurality of bandwidth part characteristics with the plurality of parameters.

5. The method (500) as claimed in claim 4, further comprising ranking the plurality of bandwidth parts based on the matched plurality of bandwidth part characteristics.

6. The method (500) as claimed in claim 5, further comprising selecting the at least one bandwidth part from the plurality of ranked bandwidth parts.

7. The method (500) as claimed in claim 6, wherein the at least one selected bandwidth part comprises of at least one bandwidth part characteristic having a maximum match with the plurality of parameters included in the establishment cause.

8. The method (500) as claimed in claim 2, wherein the plurality of parameters included in the establishment cause comprising one or more of an emergency access, a high priority access, a mobile terminating (MT) access, a mobile originating (MO) signalling, a mobile originating (MO) data, a mobile originated (MO) voice call, a mobile originated (MO) video call, a mobile originated SMS, a multimedia priority service (MPS) priority access, and a mission critical service (MCS) priority access.

9. The method (500) as claimed in claim 3, wherein the plurality of bandwidth part characteristics comprising one or more of a subcarrier spacing (SCS), load, an aggregation level, a coreset size, interleaved control channel element (CCE) indexes, non-interleaved control channel element (CCE) indexes, and channel report.

10. The method (500) as claimed in claim 1, further comprising monitoring a channel measurement report of the UE (204) attached to the allocated at least one bandwidth part.

11. The method (500) as claimed in claim 10, further comprising switching the UE (204) to at least one other ranked bandwidth part based on the monitored channel measurement report.

12. A system (210) for selecting at least one bandwidth part for a user equipment (UE) (204) connected to a network (203), the system (210) comprising:
a receiving unit (212) configured to receive a radio resource control (RRC) connection setup request from the UE (204);
a processing unit (214) coupled to the receiving unit (212) and is configured to:
check an establishment cause associated with the received RRC connection setup request;
configure a plurality of bandwidth parts based on the checked establishment cause;
select at least one bandwidth part from the plurality of configured bandwidth parts;
allocate, to the UE (204), the at least one selected bandwidth part;
transmit, to the UE (204), a RRC reconfiguration message comprising the allocated at least one bandwidth part; and
attach the UE (204) to the allocated at least one bandwidth part.

13. The system (210) as claimed in claim 12, wherein the establishment cause includes a plurality of parameters associated with a service requirement of the UE (204).

14. The system (210) as claimed in claim 13, wherein the plurality of configured bandwidth parts comprises a plurality of bandwidth part characteristics.

15. The system (210) as claimed in claim 14, further configured to match the plurality of bandwidth part characteristics with the plurality of parameters.

16. The system (210) as claimed in claim 15, further configured to rank the plurality of bandwidth parts based on matched plurality of bandwidth part characteristics.

17. The system (210) as claimed in claim 16, further configured to select the at least one bandwidth part from the plurality of ranked bandwidth parts.

18. The system (210) as claimed in claim 17, wherein the at least one selected bandwidth part comprises of at least one bandwidth part characteristic having a maximum match with the plurality of parameters included in the establishment cause.

19. The system (210) as claimed in claim 13, wherein the plurality of parameters included in the establishment cause comprising one or more of an emergency access, a high priority access, a mobile terminating (MT) access, a mobile originating (MO) signalling, a mobile originating (MO) data, a mobile originated (MO) voice call, a mobile originated (MO) video call, a mobile originated SMS, a multimedia priority service (MPS) priority access, and a mission critical service (MCS) priority access.

20. The system (210) as claimed in claim 14, wherein the plurality of bandwidth part characteristics comprising one or more of a subcarrier spacing (SCS), load, an aggregation level, a coreset size, interleaved control channel element (CCE) indexes, non-interleaved control channel element (CCE) indexes, and channel report.

21. The system (210) as claimed in claim 12, further configured to monitor a channel measurement report of the UE (204) attached to the allocated at least one bandwidth part.

22. The system (210) as claimed in claim 21, further configured to switch the UE (204) to at least one other ranked bandwidth part based on the monitored channel measurement report.

23. A network (203) comprising one or more network elements for selecting at least one bandwidth part for a user equipment (UE) (204) communicatively coupled to the network (203), the one or more network elements are configured to:
receive a radio resource control (RRC) connection setup request from the UE (204);
check an establishment cause associated with the received RRC connection setup request;
configure a plurality of bandwidth parts based on the checked establishment cause;
select at least one bandwidth part from the plurality of configured bandwidth parts;
allocate, to the UE (204), the at least one selected bandwidth part;
transmit, to the UE (204), a RRC reconfiguration message comprising the allocated at least one bandwidth part; and
attach the UE (204) to the allocated at least one bandwidth part.

24. A user equipment (UE) (204) communicatively coupled with a network (203), the network (203) comprising one or more network elements configured for:
receiving a radio resource control (RRC) connection setup request from the UE (204);
sending an acknowledgment of the RRC connection setup request to the UE (204);
checking an establishment cause associated with the received RRC connection setup request for configuring a plurality of bandwidth parts;
allocating, to the UE (204), at least one bandwidth part based on the checked establishment cause; and
transmitting, to the UE (204), a RRC reconfiguration message for attaching the UE (204) to the at least one bandwidth part.

25. A computer program product comprising a non-transitory computer-readable medium comprising instructions that, when executed by one or more processors, cause the one or more processors to perform a method (500) of selecting a bandwidth part for a user equipment (UE) (204) to a network (203), the method comprising:
receiving (502) a radio resource control (RRC) connection setup request from the UE (204);
checking (504) an establishment cause associated with the received RRC connection setup request;
configuring (506) a plurality of bandwidth parts based on the checked establishment cause;
selecting (508) at least one bandwidth part from the plurality of configured bandwidth parts;
allocating (510), to the UE (204), the at least one selected bandwidth part;
transmitting (512), to the UE (204), a RRC reconfiguration message comprising the allocated at least one bandwidth part; and
attaching (514) the UE (204) to the allocated at least one bandwidth part.
